(19) United States
(12) Patent Application Publication
(10) Pub. No.: US 2009/0234703 A1
(43) Pub. Date: Sep. 17, 2009

(54) Method and system for remote tracking of assets

(75) Inventor: Haroon Rasheed, Bangalore (IN)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: Xora, Inc.

(21) Appl. No.: 12/381,808

(22) Filed: Mar. 17, 2009

Related U.S. Application Data
(60) Provisional application No. 61/069,744, filed on Mar. 17, 2008.

(51) Int. Cl. G06Q 10/00; G01C 21/00

(52) U.S. Cl. 705/9; 705/28; 701/300

(57) ABSTRACT

A method and system for remote tracking of assets. According to one embodiment of the invention, the method for remote tracking comprises receiving location information, receiving a status of a remote asset, creating a task based on the status of the remote asset, determining a receiver to perform the task, and informing the determined receiver of the task. In one embodiment, the system for remote tracking of assets comprises a receiver, an asset, and a controller. The receiver receives location information and transmits the location information to the controller. The asset transmits status data to the controller. The controller receives the location information and status information and transmits task information to the receiver.

### CROSS-REFERENCE TO RELATED APPLICATIONS

This Application claims benefit of U.S. Provisional Patent Application Ser. No. 61/069,744, filed Mar. 17, 2008 which is herein incorporated by reference.

### BACKGROUND OF THE INVENTION

1. Field of the Invention

Embodiments of the present invention generally relates to tracking of assets and, more particularly, to methods and systems for remote tracking of assets.

2. Description of the Related Art

Many organizations conduct business through remote sites or assets. For example, a bank or a financial institution has assets, such as Automated Teller Machines (ATM), cash acceptors, cash recyclers, and currency sorters that provide bank customers and tellers access to accounts. Various airlines have assets, such as self check-in kiosks at the airports used for checking in, printing boarding passes, and checking baggage. In recent years, such assets have become a commonly used mode of commerce for many customers. Many such assets are remote and intend to serve the purpose of anytime, anywhere service. Therefore, the assets must have high availability.

However, these assets may malfunction at times, causing inconvenience to the users. To ensure proper functioning of ATM machines, the organizations may deploy field technicians that inspect asset in various locations. For example, a field technician may inspect ATM machines, identify the cause of malfunctions, and correct them. Such inspection requires extensive manpower and a high level of coordination. Despite such inspections, an ATM machine may malfunction in the intermittent time between periodic visits from a technician. Visits by field technicians may not be sufficient to sustain high availability.

In some cases, organizations remedy the problems with their assets by directing the field technicians through use of a call center or a helpdesk. Such call centers, although helpful, face problems in using field technicians effectively adding costly overhead, and an inability to facilitate repair of assets in a timely and efficient manner.

Accordingly, there exists a need for an improved method and system for remote tracking of assets that facilitates an effective and efficient way for maintenance and repair of such assets.

### SUMMARY OF THE INVENTION

Embodiments of the present invention generally include a method and system for remote tracking of assets. According to one embodiment of the invention, the method for remote tracking comprises receiving location information, receiving a status of a remote asset, creating a task based on the status of the remote asset, determining a receiver to perform the task, and informing the determined receiver of the task.

In one embodiment, the system for remote tracking of assets comprises a receiver, an asset, and a controller. The receiver receives location information and transmits the location information to the controller. The asset transmits status data to the controller. The controller receives the location information and status information and transmits task information to the receiver.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a system for remote tracking of assets according to various embodiments of the present invention;

FIG. 2 is a block diagram illustrating a receiver according to various embodiments of the present invention;

FIG. 3 is a block diagram illustrating an asset system according to various embodiments of the present invention; and

FIG. 4 is a flow diagram illustrating a method for remote tracking of assets according to various embodiments of the present invention;

While the invention is described herein by way of example using several embodiments and illustrative drawings, those skilled in the art will recognize that the invention is not limited to the embodiments of drawing or drawings described. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the word “a” means “at least one” and the word “plurality” mean one or more, unless otherwise mentioned.

### DETAILED DESCRIPTION

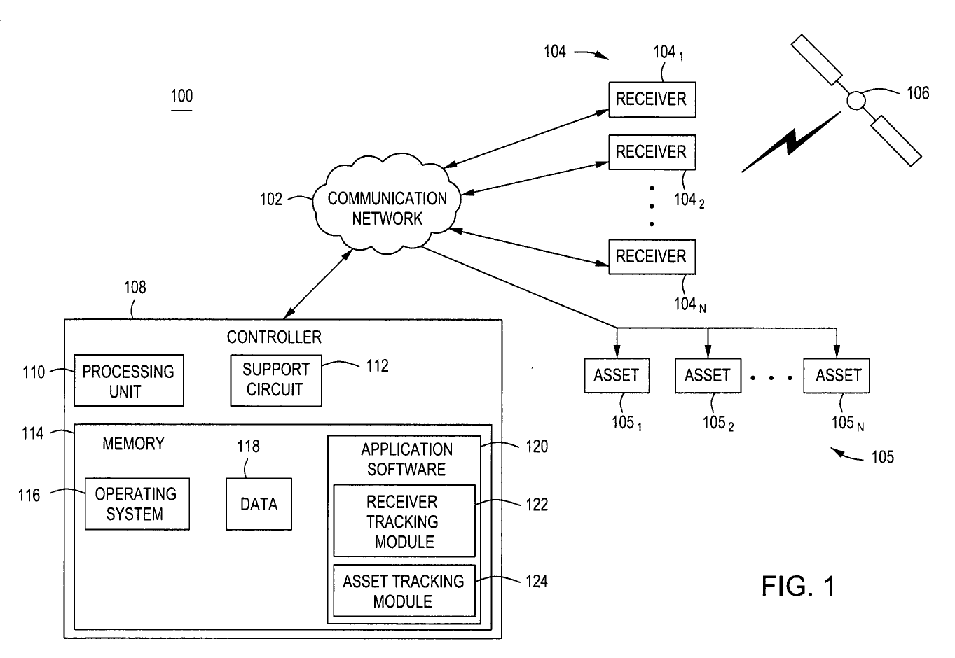

FIG. 1 is a block diagram illustrating a system 100 for remote tracking of assets according to various embodiments of the present invention. The system 100 is used to track assets, report malfunctions, and dispatch the nearest technicians.

The asset tracking system 100 comprises a communication network 102, receivers 104₁, 104₂ . . . 104ₙ (collectively referred to as receiver 104), assets 105₁, 105₂ . . . 105ₙ (collectively referred to as asset 105), a network of Global Navigation Satellite System (GNSS) satellites 106 (e.g. Global Positioning System (GPS), Galileo, GLONASS, and the like), and a controller 108. The controller 108 communicates with the receiver 104 and/or the assets 105 via the communication network 102. The communication network 102 may be a public and/or a private network, such as the Internet, a Local Area Network (LAN), Wide Area Network (WAN) and the like. Typically, the receiver 104 communicates by wireless signals with the communication network 102. In one embodiment, the receiver 104 is a mobile device (e.g., cellular telephone) and/or a computer comprising GNSS receiver. In another embodiment, the receiver 104 is purpose built tracking device, e.g., a personal navigation device (PND).

The GNSS satellites' 106 signals include well-known information from which a receiver 104 computes a position. The receiver 104 utilizes the signals received from the GNSS satellites 106 to determine, in a well known manner, a position of the receiver 104. According to one embodiment, the processing of the signal may comprise decoding the satellite signals to recover satellite navigation data using decoding process known in the art. In an alternative embodiment, the receiver 104 receives and transmits the received GNSS signals or information extracted from the GNSS signals to the controller 108. In such an embodiment, the controller 108 processes the signals and computes the location of the receiver 104. Whether the controller 108 computes the location or the receiver 104 computes the location is irrelevant to the invention. The controller is informed of the location of each receiver 104 and, consequently, the location of each technician associated with each receiver 104.

The asset 105 may be any kiosk-like asset utilized by customers to conduct business at a remote location, such as accessing account data, checking in, and the like. For example, an asset 105 may be an Automated Teller Machine (ATM), a computing kiosk, an airline booth, an Internet terminal, a currency sorter, a cash recycler, and the like. The asset 105 communicates with the controller 108 via the communication network 102. The assets 105₁, 105₂ . . . 105ₙ may be located in various locations and may represent various businesses. The controller 108 may provide a service to a number of assets 105 for different commercial entities. In one embodiment, the asset 105 may include some or all the features of the receiver 104. For example, the asset 105 may receive the GNSS signals and compute its location information, then report that location to the control 108.

The controller 108 may be electronic device such as a computer, a computer server, a mobile device or any such known device known in the art. The controller 108 comprises at least one processing unit 110, support circuits 112 and memory 114. The processing unit 110 may comprise one or more conventionally available microprocessors. The support circuits 112 are well known circuits used to promote functionality of the processing unit 110. Such circuits include, but are not limited to, a cache, power supplies, clock circuits, I/O circuits and the like.

The memory 114 of the controller 108 may comprise random access memory, read only memory, removable disk memory, flash memory, and various combinations of these types of memory. The memory 108 is sometimes referred to as main memory and may, in part, be used as cache memory or buffer memory. The memory 108 generally stores the operating system 116. The operating system 116 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like.

In addition, the memory 208 may store data 118 and various forms of application software 120, such as an asset tracking module 124. The data 118 may comprise a relational database, for example, SQL from Oracle Corporation. The data 118 may be utilized by the OS 116 and/or the application software 120. The controller 108 utilizes the receiver tracking module 122 to communicate with and/or track the receivers 104. The controller 108 utilizes the asset tracking module 124 to communicate with and/or track assets 105

In cases where the receiver 104 is not stationary, the receiver tracking module 122 utilizes the updated information related to the position of the receiver 104 and computes the position of the receiver 104 accordingly. The asset tracking module 124 is configured to track assets 105. Those skilled in the art will appreciate that the remote tracking of the assets 105 by the asset tracking module 124 may include locating, configuring and/or monitoring the asset 105.

The controller 108 may be coupled to I/O device. The I/O device is utilized to input data to, retrieve data from, or display data of the controller 108. Such I/O device may be, but are not limited to, a mouse, keyboard, monitor, CD-ROM, and the like.

In one embodiment, the system 100 tracks the performance of one or more assets 105 and may monitor the performance of the individual components associated with the asset 105. The component of the asset 105 may include printer, cash dispenser, token dispenser and the like. In cases where an individual component of the asset 105 is not performing to the desired level of functionality or is running low on a consumable (e.g., paper), a report of the issue is communicated to the controller 108. Generally, the asset tracking module 124 performs the remote tracking of the asset 105 and is capable of remotely monitoring the performance of the individual components associated with the asset 105. For example, if the asset in question is an ATM, the monitored components may include a magnetic card reader, a cash dispenser, an encrypted pin pad, a receipt printer, and the like.

In alternative embodiments, the asset tracking module 124 does not actively monitor the function of the asset 105. In such an embodiment, the report related to asset function may be sent by a separate unit included in the asset 105. The unit may comprise an asset tag configured to track the function of each component of the asset 105. The unit may further comprise a communication device configured to communicate with the asset tracking module 124. In case of a malfunction of the asset 105, the unit may send a report related to the malfunction to the controller 108. The report may include the description of the malfunctioning component, asset number/identification, location and the like. In another embodiment, the malfunctioning of an asset 105 is reported to a technician nearest to the malfunctioning asset 105. Each technician (service provider) is associated with a receiver and the receiver locations are tracked by the controller. Thus, the controller identifies the nearest technician and notifies the nearest technician of a service requirement. The computed location of the malfunctioning asset 105 may further be plotted onto a map by the controller 108 and sent to the technician's receiver. The technician may not be stationary and hence, the map/location is periodically updated.

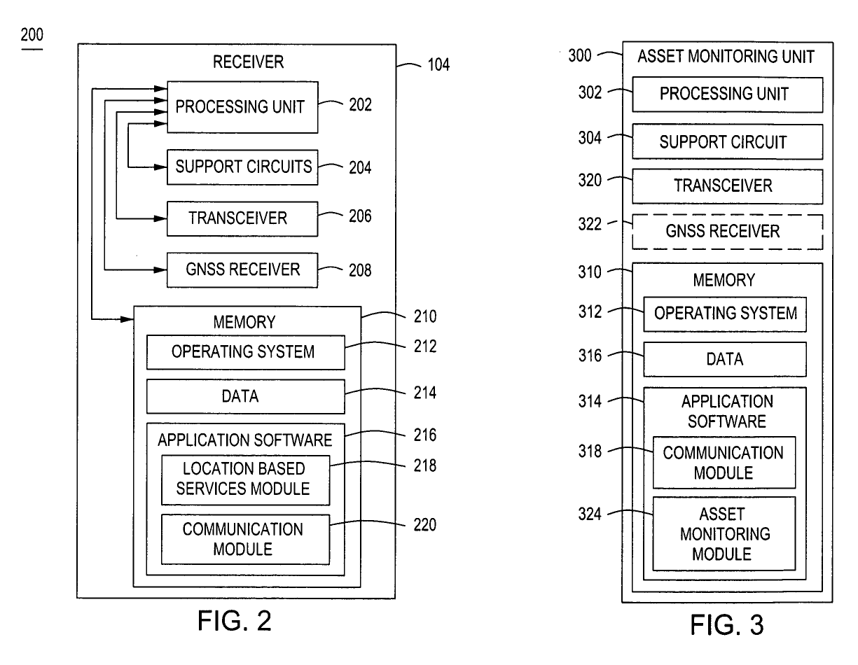

FIG. 2 illustrates a receiver 200 according to one embodiment of the present invention. The receiver 200 includes a processing unit 202, support circuit 204, transceiver 206, GNSS receiver 208, and memory 210. The processing unit 202 may comprise one or more conventionally available microprocessors. The support circuits 204 are well known circuits used to promote functionality of the processing unit 202. The support circuits 204 may include conventional cache, power supplies, clock circuits, data registers, I/O circuitry, and the like to facilitate operation of the receiver 200.

The transceiver 206 is a combination of transmitter/receiver used for wireless communications devices such as cellular telephones, cordless telephone sets, handheld two-way radios, mobile two-way radios and the like. The GNSS receiver 208 may include electronic equipment that receives GNSS signals for processing. Those skilled in the art will appreciate that the GNSS receiver 208 receives the GNSS satellites signals and computes the location of the receiver 200.

The memory 210 may be random access memory, read only memory, for example PROM, EPROM, EEPROM and the like, removable storage such as optical disk, tape drive and the like, hard disk storage, flash drives or any combination of such memory devices. The memory 210 may include an operating system (OS) 212, data 214 and application software 216. The operating system 212 may be one of a number of commercially available operating systems used in mobile devices.

The application software 216 may include one or more applications utilized/executed by the processing unit 202, such as a location based services (LBS) module 218. The LBS module 218 processes GNSS signals and/or positions and reports the positions to the controller. The LBS module 218 also receives information from the controller to facilitate asset service notification. The communication module 220 is used to communicate information to and from the controller 108 using the transceiver.

In one embodiment of the invention, the receiver 104 is an LBS-enabled cellular telephone.

FIG. 3 is a block diagram illustrating an asset monitoring unit 300 according to various embodiments of the present invention. In one embodiment, the asset monitoring unit 300 may be a subcomponent of an asset 105. In another embodiment, the asset monitoring unit 300 may be located remotely from the monitored asset 105. The asset monitoring unit 300 includes a processing unit 302, support circuit 304, memory 310, a transceiver 320 and, an optional, and a GNSS receiver 322. The processing unit 302 may comprise one or more conventionally available microprocessors. The support circuits 304 are well known circuits used to promote functionality of the processing unit 302. The support circuits 304 may include conventional cache, power supplies, clock circuits, data registers, I/O circuitry, and the like to facilitate operation of the asset system 300.

The memory 310 may be random access memory, read only memory, for example PROM, EPROM, EEPROM and the like, removable storage such as optical disk, tape drive and the like, hard disk storage, flash drives or any combination of such memory devices. The memory 310 may include an operating system (OS) 312, data 316 and application software 314. The operating system 312 may be one of a number of commercially available operating systems. The transceiver 320 communicates with the network (102 of FIG. 1). The transceiver 320 may be a wireless (e.g., cellular telephone, Bluetooth, pager, Wi-Fi (802.11x and the like) and/or wired communication network (e.g., Ethernet, CATV network, fiber optic network and the like). The transceiver 320 communicates information regarding asset status to the controller (108 in FIG. 1) as described below.

The asset monitoring unit 300 may optionally comprise a GNSS receiver 322. If the unit 300 and its associated asset are stationary (fixed), the location may be known to the unit 300 and the controller without the need of a GNSS receiver. However, if the unit 300 and its asset are mobile, a GNSS receiver 322 can be used to provide location information to the controller. The GNSS receiver 322 conventionally receives and processes GNSS satellite signals to compute a position. The position is then communicated to the controller using the transceiver 320. Such position transmissions may be intermittent or periodic.

The application software 314 may include one or more applications executed/utilized by the processing unit 302, such as a communication module 318 and an asset monitoring module 324. The asset monitoring module 324 monitors asset performance, including malfunction detection and reporting. The communication module 318 is utilized to communicate asset status information to the controller 108 (shown in FIG. 1) using the transceiver 320. In operation, the asset monitoring module 324 generates asset status information (including malfunctions) that is coupled to the communication module 314. The communication module 314 combines the status information with the asset position (if necessary) and couples the combined information to the transceiver 320 for transmission to the controller.

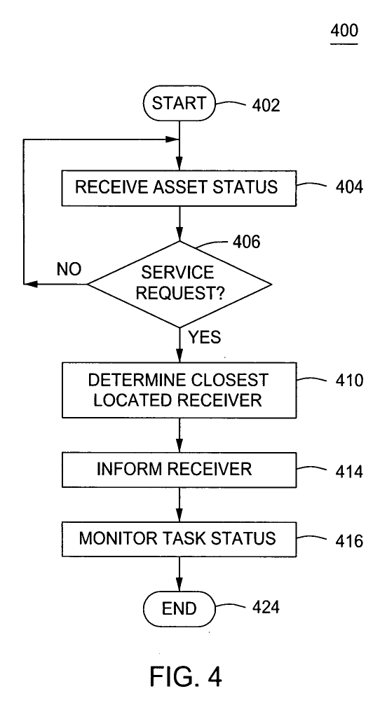

FIG. 4 is a flow diagram illustrating a method 400 performed by the controller for remote tracking of assets according to various embodiments of the present invention. The method 400 starts at step 402. In one embodiment, the method may begin due to an “on-demand” status request from the controller. In another embodiment, the asset 105 may report the status due to a status change such as a malfunction, or due to a time interval having expired. When the asset has reported a status, the method proceeds to step 404. At step 404, the controller receives an asset status transmission. In one embodiment, the asset status transmission may include the status of specific subcomponents of the asset. At step 406, the controller determines if the message contains a service notice. If there is not a need for service, the method 400 proceeds to step 404 to await the next status communication. The communication can be performed via an ‘on demand’ request from the controller, periodic transmissions from the asset, or intermittent transmissions upon a request for service.

If there is a service request, the method 400 proceeds to step 410 and determines the closest receiver to the location of the malfunctioning asset. At step 414, the controller 108 informs the nearest receiver (i.e., a technician) of the malfunctioning asset and of relevant information, such as an asset identification number, location, problem, directions to the asset, maintenance history, and the like.

At step 416, the controller 108 may monitor the status of the maintenance task. The job status may be updated by a technician reporting the service is complete, or the asset monitoring unit 300 may update the controller directly. In this manner, the controller may update its records upon correction of the malfunction. The technician may also be dispatched to perform regular (e.g., periodic) maintenance. The maintenance records would be updated upon completion of the scheduled maintenance. The method 400 ends at step 424.

While the foregoing is directed to embodiments of the present invention, other and further embodiments of the invention may be devised without departing from the basic scope thereof.

What is claimed is:

1. A method for remote tracking of assets comprising:
receiving the status of a remote asset;
receiving the location of one or more receivers;
creating a task based upon the status of the remote asset;
determining a receiver for the created task; and
informing the determined receiver of the created task.

2. The method of claim 1, further comprising informing the receiver of the status of the remote asset.

3. The method of claim 1, further comprising tracking the status of the task.

4. The method of claim 1, wherein the task is a maintenance or repair task related to the remote asset.

5. The method of claim 1, wherein the determining step further comprises selecting the receiver closest to the remote asset based upon the received location.

6. The method of claim 1 further comprising calculating the location of the receiver by receiving signals from GNSS satellites.

7. A system for remote tracking of assets comprising:
a receiver for receiving location information and transmitting the location information to a controller;
an asset for transmitting status data to the controller; and
the controller for receiving the status data and the location information and sending task information to the receiver.

8. The system of claim 7 wherein the status data comprises information indicating the asset requires maintenance.

9. The system of claim 7 wherein the controller creates a maintenance task as a result of the received status data.

10. The system of claim 9 wherein the maintenance task is sent to the receiver.

11. The system of claim 9 wherein the status of the asset is sent to the receiver.

12. The system of claim 10 wherein the controller tracks the status of the maintenance task.

13. The system of claim 10 wherein the controller continuously tracks the status of the asset.

14. The system of claim 10 wherein the receiver to which the task is sent is determined by the location of the receiver in relation to a location of the asset.

15. The system of claim 14 wherein the task is sent to the closest receiver to the asset.
